(19) United States
(12) Patent Application Publication
(10) Pub. No.: US 2025/0315704 A1
(43) Pub. Date: Oct. 9, 2025

(54) SYSTEMS AND METHODS FOR CERTIFYING RANDOMNESS FROM RANDOM CIRCUIT SAMPLING ON QUANTUM PROCESSORS WITH LOW CLOCK RATES

(71) Applicant: JPMORGAN CHASE BANK, N.A., New York, NY (US)

(72) Inventors: Ruslan SHAYDULIN, New York, NY (US); Pradeep NIROULA, College Park, MD (US); Marco PISTOIA, Amawalk, NY (US); Andrew LANG, Avon, CT (US); Minzhao LIU, Chicago, IL (US)

(21) Appl. No.: 18/625,605

(22) Filed: Apr. 3, 2024

(51) Int. Cl. G06N 10/20; G06N 10/70

(52) U.S. Cl. CPC G06N 10/20; G06N 10/70

(57) ABSTRACT

A method may include: (1) generating, by a classical computer program executed by a client electronic device, a pseudorandom graph having a depth, a number of nodes based on a number of qubits in a quantum computer, and edges between the nodes; (2) creating, by the classical computer program, a coloring of the graph such that no two edges that share a node have the same color; (3) creating, by the classical computer program, a graph coloring layer for each color that includes edges with that color; (4) generating, by the classical computer, a quantum circuit from the graph coloring layers; (5) estimating, by the classical computer program, a cost of validating the quantum circuit; (6) determining, by the classical computer program, that the cost is acceptable; and (7) saving, by the classical computer program, the quantum circuit in response to the cost being acceptable.

### BACKGROUND OF THE INVENTION

### 1. Field of the Invention

Embodiments relate to systems and methods for certifying randomness from random circuit sampling on quantum processors with low clock rates.

### 2. Description of the Related Art

Certain classical computer systems rely on the generation of random numbers to perform many functions, including password generation, market simulation, random user selection for promotion, etc. In order to increase the entropy of the random numbers by a local random number generator, U.S. Patent Application Publication Number 2022/0100473 to Aaronson proposes a classical computer client issuing a quantum circuit to a quantum computer system, and sampling the output of the quantum computer system multiple times on the same circuit. The disclosure of U.S. Patent Application Publication Number 2022/0100473 is hereby incorporated, by reference, in its entirety.

Security of the protocol relies on the assumption that no classical adversary can simulate the output of the quantum computer system within the time in which the samples were returned. At the same time, the cost of classical simulation grows sublinearly with number of samples. Each sample using the quantum computer system takes a certain fixed amount of time that does not decrease if more samples are taken. Thus, taking repeated samples from the same circuit using the quantum computer system leads to reduced gap between per-sample time of the quantum computer and per-sample time to perform classical simulation. This increases the possibility of an attack between the classical computer system and the quantum computer system. This is possible even with as little as 20 sequential samples.

### SUMMARY OF THE INVENTION

Systems and methods for certifying randomness from random circuit sampling on quantum processors with low clock rates are disclosed. According to an embodiment, a method may include: (1) generating, by a classical computer program executed by a client electronic device, a pseudorandom graph having a depth, a number of nodes based on a number of qubits in a quantum computer, and edges between the nodes; (2) creating, by the classical computer program, a coloring of the graph such that no two edges that share a node have the same color; (3) creating, by the classical computer program, a graph coloring layer for each color that includes edges with that color; (4) generating, by the classical computer, a quantum circuit from the graph coloring layers; (5) estimating, by the classical computer program, a cost of validating the quantum circuit; (6) determining, by the classical computer program, that the cost is acceptable; and (7) saving, by the classical computer program, the quantum circuit in response to the cost being acceptable.

In one embodiment, the method may also include changing, by the classical computer program, the depth in response to the cost being unacceptable.

In one embodiment, the method may also include increasing, by the classical computer program, the depth in response to the cost being below a cost threshold.

In one embodiment, each edge represents a two-qubit gate.

In one embodiment, a number of edges may be equal to the depth.

In one embodiment, the step of generating a quantum circuit from the graph coloring layers may include concatenating the graph coloring layer.

In one embodiment, for each graph coloring layer, a fixed two-qubit may be appended to the quantum circuit, and for each qubit, a single qubit gate that may be sampled uniformly from the space of all possible gates on a single qubit may be appended to the quantum circuit.

In one embodiment, the cost may be based on a number of floating-point operations required to validate the quantum circuit, a time to validate the quantum circuit, etc.

According to another embodiment, a method may include: (1) maintaining, by a classical computer program executed by a client electronic device, a running average score of randomness; (2) obtaining, by the classical computer program, a seed of entropy from a pool of entropy; (3) generating, by the classical computer program, a plurality of pseudorandom quantum circuits using the seed; (4) sending, by the classical computer program, the plurality of pseudorandom quantum circuits to a quantum computer, wherein the quantum computer may be configured to execute the plurality of pseudorandom quantum circuits, resulting in a sample comprising sequence of random bits for each of the plurality of pseudorandom quantum circuits; (5) receiving, by the classical computer program, the samples from the quantum computer; (6) randomly selecting, by the classical computer program, a subset of the plurality of pseudorandom quantum circuits and their samples; (7) creating, by the classical computer program, a tensor network for each pseudorandom quantum circuit in the subset; (8) setting, by the classical computer program, output indices for each tensor network to be equal to the sample for the pseudorandom quantum circuit; (9) obtaining, by the classical computer program, a probability that each of the pseudorandom quantum circuit in the subset created the sample for the pseudorandom quantum circuit; (10) adding, by the classical computer program, the probability for each of the pseudorandom quantum circuits to the running average score of randomness; (11) comparing, by the classical computer program, the running average score of randomness to a threshold; and (12) accepting, by the classical computer program, each of the samples in response to the running average score of randomness being greater than an average score of randomness threshold.

In one embodiment, the seed of entropy may include a value of CPU jitter, time value, and/or a value based on a pattern of memory access.

In one embodiment, the step of generating the pseudorandom quantum circuit using the seed may include seeding, by the classical computer program, a pseudorandom function with the seed.

In one embodiment, the threshold may be based on a fidelity of the quantum computer, a security parameter, etc.

In one embodiment, the method may also include: measuring, by the classical computer program, a time for the quantum computer program to return the samples; and rejecting, by the classical computer program, the samples in response to the time being outside of a time threshold.

According to another embodiment, a non-transitory computer readable storage medium, including instructions stored thereon, which when read and executed by one or more computer processors, cause the one or more computer processors to perform steps comprising: generating a pseudorandom graph having a depth, a number of nodes based on a number of qubits in a quantum computer, and edges between the nodes; creating a coloring of the graph such that no two edges that share a node have the same color; creating a graph coloring layer for each color that includes edges with that color; generating a quantum circuit from the graph coloring layers; estimating a cost of validating the quantum circuit; determining that the cost is acceptable; and saving the quantum circuit in response to the cost being acceptable.

In one embodiment, the non-transitory computer readable storage medium may also include instructions stored thereon, which when read and executed by one or more computer processors, cause the one or more computer processors to perform steps comprising: increasing the depth in response to the cost being below a cost threshold.

In one embodiment, each edge represents a two-qubit gate, and a number of edges may be equal to the depth.

In one embodiment, the quantum circuit may be generated by concatenating the graph coloring layer, and for each graph coloring layer, a fixed two-qubit may be appended to the quantum circuit, and for each qubit, a single qubit gate that may be sampled uniformly from the space of all possible gates on a single qubit may be appended to the quantum circuit.

In one embodiment, the cost may be based on a number of floating-point operations required to validate the quantum circuit or a time to validate the quantum circuit.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for certifying randomness from random circuit sampling on quantum processors with low clock rates according to an embodiment;

FIG. 2 illustrates a method for certifying randomness from random circuit sampling on quantum processors with low clock rates according to an embodiment;

FIGS. 3A and 3B illustrate a method for certifying randomness from random circuit sampling on quantum processors with low clock rates according to another embodiment; and

FIG. 4 depicts an exemplary computing system for implementing aspects of the present disclosure.

### DETAILED DESCRIPTION OF PREFERRED EMBODIMENTS

Embodiments relate to systems and methods for certifying randomness from random circuit sampling on quantum processors with low clock rates.

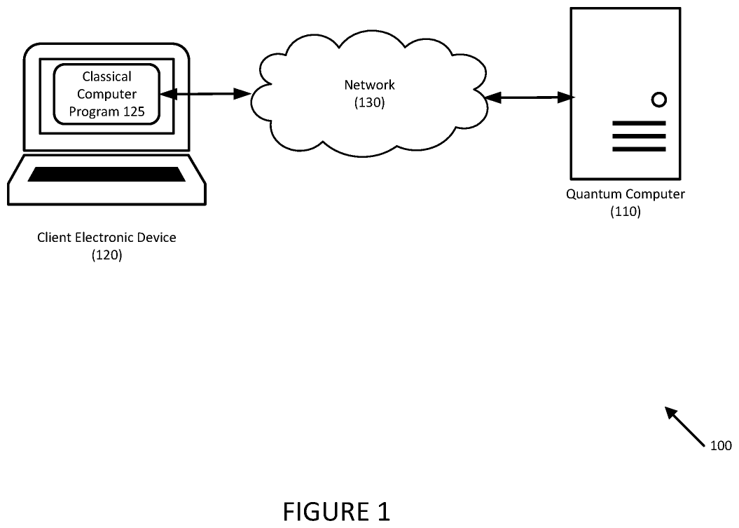

Referring to FIG. 1, a system for certifying randomness from random circuit sampling on quantum processors with low clock rates is disclosed according to an embodiment. System 100 may include quantum computer 110 that may execute a quantum circuit, such as a pseudorandom quantum circuit. A quantum circuit is a model for quantum computation that may include a sequence of quantum gates, measurements, initializations of qubits to known values, etc.

Quantum computer 110 may be a device that performs quantum computations, such as those based on the collective properties of quantum states including superposition, interference, and entanglement. In one embodiment, quantum computer 110 may have a low clock cycle. An example of such a quantum computer is a neutral atom quantum computer or a trapped-ion quantum computer. Other types of quantum computers may be used as is necessary and/or desired.

Client electronic device 120 may be any suitable general purpose computing device, including servers, workstations, desktops, notebooks, laptops, tablet computers, smart devices (e.g., smart phones, smart watches, etc.), Internet of Things (IoT) appliances, etc. For example, client electronic device 120 may be a microprocessor-based device. Client electronic device 120 may interface with quantum computer 110 using classical computer program 125, which may provide input to, and receive output from, quantum computer 110. In one embodiment, classical computer program 125 may generate a plurality of pseudorandom quantum circuits, may transpile the pseudorandom quantum circuit(s) to machine-readable instructions, and may then send the transpiled circuit(s) over network 130 to quantum computer 110 for execution. Classical computer program 125 may also receive the results of the execution of the pseudorandom quantum circuits from quantum computer 110 also over network 130. For example, classical computer program 125 may receive a sample from the execution of the pseudorandom quantum circuits.

In one embodiment, network 130 may be a public network such as the Internet.

Classical computer program 125 may also certify the randomness of the samples from quantum computer 110. For example, classical computer program 125 may determine whether the time it takes for the quantum computer program to return a sample is outside of a time threshold. If the time is outside of the time threshold, indicating a possible attack, classical computer program 125 may reject the sample.

Classical computer program 125 may also validate the sample using a tensor network representing the pseudo-random circuit. The goal of validation is to make sure that the samples received from the quantum source actually came from the pseudo-random circuits that were submitted and were not tampered with. Thus, to validate, the probability that a sample actually came from the pseudorandom quantum circuit is calculated using, for example, a tensor network.

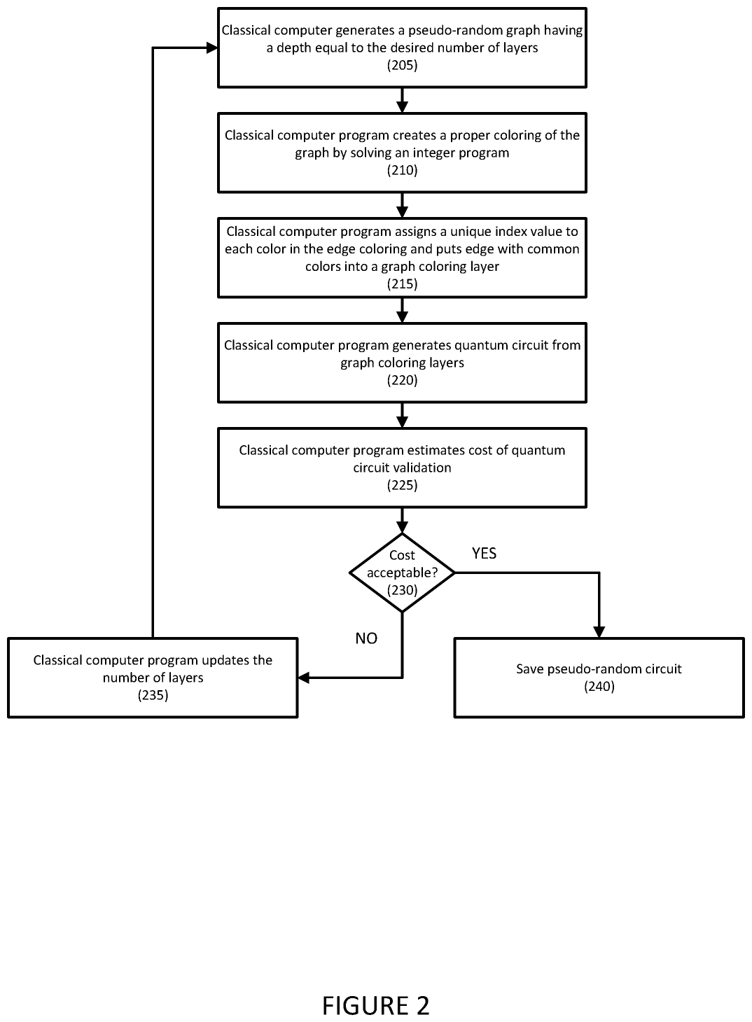

Referring to FIG. 2, a method for certifying randomness from random circuit sampling on quantum processors with low clock rates is disclosed according to an embodiment.

In step 205, a classical computer program executed by a client electronic device may generate a pseudorandom graph having a depth (d) equal to the desired number of layers. In one embodiment, the depth may be specified by the user and may be determined based on the amount of computational power is available to validate the randomness. For example, a greater amount of depth may be used with a supercomputer.

In one embodiment, the pseudorandom graph may obey certain properties of random graphs with a high probability.

In one embodiment, the number of nodes may be based on a desired number of qubits of the quantum computer that is being used. For example, the number of nodes may be between 50 and 70. Each edge may represent a two-qubit gate.

In one embodiment, each node in the graph may be a d-regular graph, and each node may have d neighbors (i.e., equal to the depth).

In step 210, the classical computer program may create a proper d-coloring of the graph by solving an integer program. For example, given d colors, each edge of the graph may be colored with one of the d colors so that there are no repetitions of colors among edges that share a node.

For example, in a d-regular graph, each node has d edges. Edge d-coloring or simply “edge coloring” assigns one of d colors such that all edges belonging to a node have different colors.

In step 215, the classical computer program may assign a unique index value to each color in the edge coloring and may create a list denoted as a “graph coloring layer.” Such a list may contain for each color the edges with that color.

In step 220, the classical computer may generate a quantum circuit, such as a pseudorandom quantum circuit, from the graph coloring layers. For example, each color may provide a layer, and the quantum circuit may be generated by adding together all the layers in sequence.

In one embodiment, the layers may be concatenated (i.e., linked) to create a circuit; in other words, a circuit is created by appending layers, starting with an empty circuit with zero layers and ending with the full circuit with d layers after d repetitions. For example, for each graph coloring layer, the classical computer program may append a fixed two qubit gate to the circuit, such as a

$$ZZ \frac{π}{2}$$

gate, and for each qubit, a single qubit gate, sampled uniformly from the space of all possible gates on a single qubit, may be appended.

In step 225, the classical computer program may estimate the cost of quantum circuit validation. The cost of a quantum circuit may vary based on the geometry of the graph that is used to generate the circuit. The cost of a circuit may depend on the geometry of the graph from which the pseudorandom quantum circuit is based on. For example, the cost may depend on the number of gates, the depth, the type of gates etc.

In one embodiment, cost may be measured in terms of computing power, such as the number of floating-point operations required (e.g., arithmetic calculations using floating-point numbers), time, dollar cost, etc.

An acceptable cost is something low enough that is within reach of powerful supercomputers but is large enough that the circuit cannot be readily simulated by an adversary.

In step 230, if the cost is acceptable, in step 240, the classical computer program may save the quantum circuit.

If the cost is unacceptable, in step 235, the classical computer program may update the number of layers. It may also change the number of gates, etc. For example, if the cost is too low (e.g., below a lower cost threshold), the classical computer program may increase the number of layers, may add gates, etc. If the cost is too high (e.g., above an upper cost threshold), the classical computer program may decrease the number of layers, may decrease the number of gates, etc.

The cost thresholds may be set by the user.

The process may continue to step 205.

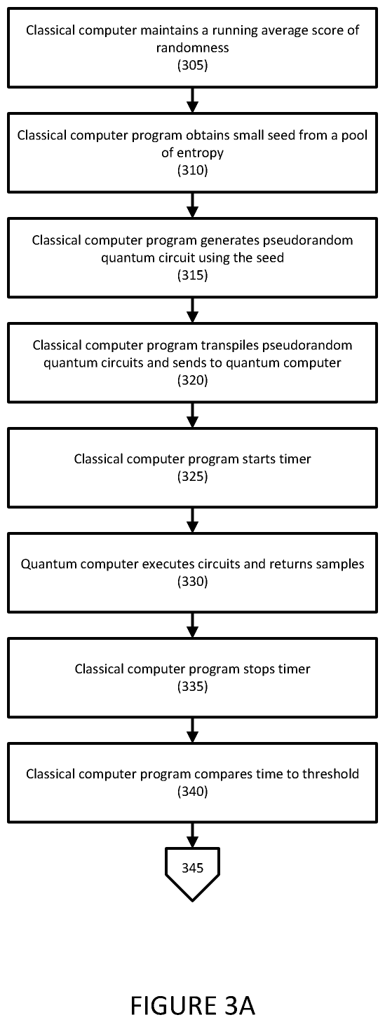

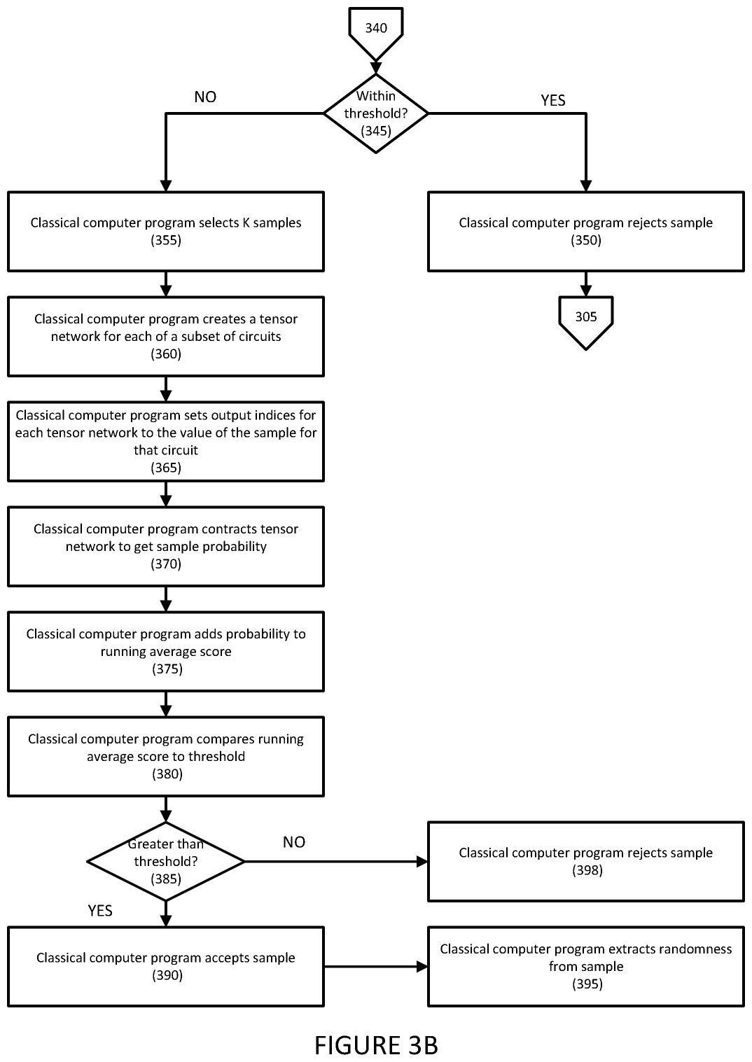

Referring to FIGS. 3A and 3B, a method for certifying randomness from random circuit sampling on quantum processors with low clock rates is disclosed according to another embodiment.

In step 305, a classical computer program executed by a client electronic device may maintain a running average score of randomness. The running average score of randomness may be the average score of randomness of the randomness score for the samples received from the quantum computer.

In step 310, the classical computer program may obtain a small seed (e.g., a value) from a pool of entropy, such as one that is maintained by client electronic device's operating system. Examples of sources of entropy may include CPU jitter, time, pattern of memory access, etc., and the seed may be a value based on one or more of these sources of entropy.

In step 315, the classical computer program may generate a pseudorandom quantum circuit using the seed. For example, the classical computer program may seed a pseudorandom function with the seed (e.g., use the seed as one of the values in the pseudorandom function) and may then generate a pseudorandom circuit using the pseudorandom function.

In one embodiment, the classical computer program may generate a plurality of pseudorandom quantum circuits using the process of FIG. 2. The number of pseudorandom quantum circuits may depend on the amount of randomness needed.

In step 320, the classical computer program may transpile the pseudorandom quantum circuits and may send each to the quantum computer for execution. In one embodiment, the classical computer program may send the transpiled quantum computer circuits to the quantum computer in batches, individually, etc.

In step 325, the classical computer program may start a timer when the transpiled pseudorandom quantum circuit is submitted to the quantum computer.

In step 330, the quantum computer may execute each pseudorandom quantum circuit and may return a sample comprising a sequence of random bits to the classical computer program.

In step 335, when the classical computer program receives the quantum sample, it may stop the timer.

In one embodiment, if a batch of pseudorandom quantum circuits is provided, a single timer may be used for the batch, and the computed time may be the average per-circuit time for the batch.

In step 340, the classical computer program may compare the timer to a time threshold. The time threshold may be based on the fidelity of the quantum computer (e.g., how closely the operation of the quantum computer aligns with an ideal quantum computer), a security parameter (e.g., a tolerance for the protocol to fail, etc.).

If, in step 345, the timer is outside of a time threshold, in step 350, the classical computer program may reject the quantum sample. Because this may be indicative of an attack, in one embodiment, the classical computer program may return to step 305 and may restart the process with a new running average score of randomness, a new seed, and a new pseudorandom quantum circuit.

If the timer is within the time threshold, in step 355, the classical computer program may randomly select a subset of K pseudorandom quantum circuits and their samples to validate with a small validation probability. The validation probability may be based on the amount of classical computation power available and may be received as a user parameter.

In step 360, the classical computer program may create a tensor network representing each of the pseudorandom quantum circuits. An example of such is described in Markov et al., “Simulating Quantum Computation by Contracting Tensor Networks,” SIAM Journal on Computing, Vol., 38, Issue 3 (2008) (available at doi.org/10.1137/050644756), the disclosure of which is hereby incorporated, by reference, in its entirety.

Next, in step 365, the classical computer program may set the output indices for each tensor network to be equal to the values of the sample received from the quantum computer program for the pseudorandom quantum circuit. The output indices are the indices of the tensor network corresponding to the outputs of the quantum circuit being represented by the tensor network.

In step 370, the classical computer program may contract the tensor network to obtain the probability of the sample coming from the circuit. For example, the sum Pr(sⱼ| Cⱼ), where Cⱼ is a pseudorandom quantum circuit, and Sⱼ is the corresponding sample received from the quantum computer. The sum represents the quantum mechanical probability, given by the tensor network, that a quantum computer executing Cⱼ would measure and return sⱼ. The tensor network calculation gives this probability.

In step 375, the probability may be added to the running average score of randomness. If the running average contains contributions from more than the number of samples that are evaluated, the contribution of the earliest added samples may be removed from the average.

In step 380, the classical computer program may compare the running average randomness score to a random score threshold.

If, in step 385, running average score of randomness is greater than the random score threshold, in step 390, the sample may be accepted. An example threshold is bK/2ⁿ wherein n is the number of qubits, K is the number of samples being validated, and b is a number between 1 and 2.

In one embodiment, b may be received as a parameter and may be based on an estimation of how close the quantum computer is to being an ideal quantum computer. If it is nearly ideal, b may be set to a value that is close to 2 (e.g., 1.9). If, however, the quantum computer is noisy, b may be set to a value that is closer to 1 (e.g., 1.1).

In step 395, the classical computer program may pass the sample through a randomness extractor that may extract randomness from sampled bits which contain randomness but are not uniform. The extracted bits are certifiably random uniform bits.

If the running average score of randomness is less than the random score threshold, bk/2ⁿ, in step 398, the sample may be rejected.

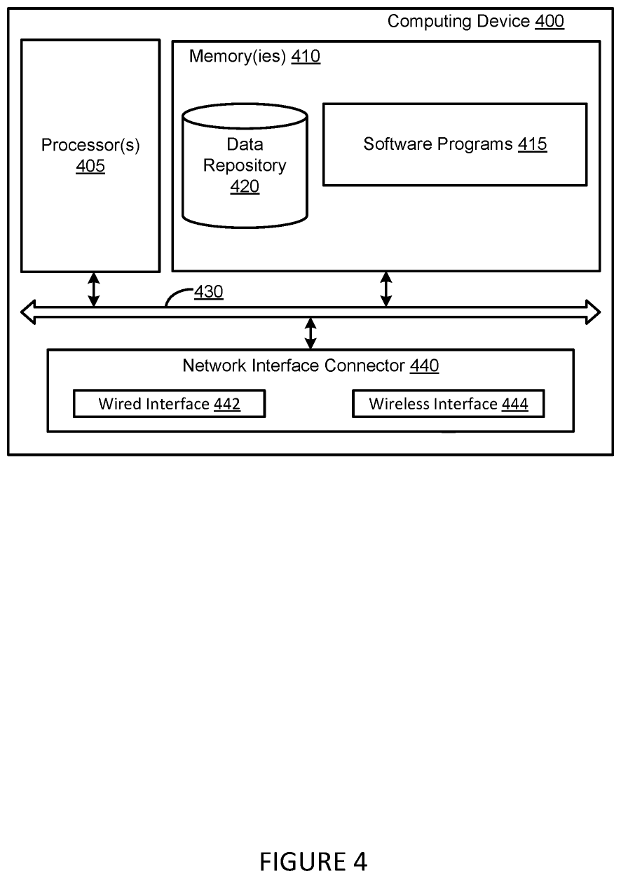

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

The disclosure of U.S. patent application Ser. No. ______ [Attorney Docket No. 052227.501587], entitled “Systems And Methods For Storage And Distribution Of Certified Randomness” to Pradeep Niroula et al., filed concurrently herewith, is hereby incorporated, by reference, in its entirety.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
generating, by a classical computer program executed by a client electronic device, a pseudorandom graph having a depth, a number of nodes based on a number of qubits in a quantum computer, and edges between the nodes;
creating, by the classical computer program, a coloring of the graph such that no two edges that share a node have the same color;
creating, by the classical computer program, a graph coloring layer for each color that includes edges with that color;
generating, by the classical computer, a quantum circuit from the graph coloring layers;
estimating, by the classical computer program, a cost of validating the quantum circuit;
determining, by the classical computer program, that the cost is acceptable; and
saving, by the classical computer program, the quantum circuit in response to the cost being acceptable.

2. The method of claim 1, further comprising:
changing, by the classical computer program, the depth in response to the cost being unacceptable.

3. The method of claim 1, further comprising:
increasing, by the classical computer program, the depth in response to the cost being below a cost threshold.

4. The method of claim 1, wherein each edge represents a two-qubit gate.

5. The method of claim 1, wherein a number of edges is equal to the depth.

6. The method of claim 1, wherein the step of generating a quantum circuit from the graph coloring layers comprises concatenating the graph coloring layer.

7. The method of claim 6, wherein for each graph coloring layer, a fixed two-qubit is appended to the quantum circuit, and for each qubit, a single qubit gate that is sampled uniformly from the space of all possible gates on a single qubit is appended to the quantum circuit.

8. The method of claim 1, wherein the cost is based on a number of floating-point operations required to validate the quantum circuit.

9. The method of claim 1, wherein the cost is based on a time to validate the quantum circuit.

10. A method, comprising:
maintaining, by a classical computer program executed by a client electronic device, a running average score of randomness;
obtaining, by the classical computer program, a seed of entropy from a pool of entropy;
generating, by the classical computer program, a plurality of pseudorandom quantum circuits using the seed;
sending, by the classical computer program, the plurality of pseudorandom quantum circuits to a quantum computer, wherein the quantum computer is configured to execute the plurality of pseudorandom quantum circuits, resulting in a sample comprising sequence of random bits for each of the plurality of pseudorandom quantum circuits;
receiving, by the classical computer program, the samples from the quantum computer;
randomly selecting, by the classical computer program, a subset of the plurality of pseudorandom quantum circuits and their samples;
creating, by the classical computer program, a tensor network for each pseudorandom quantum circuit in the subset;
setting, by the classical computer program, output indices for each tensor network to be equal to the sample for the pseudorandom quantum circuit;
obtaining, by the classical computer program, a probability that each of the pseudorandom quantum circuit in the subset created the sample for the pseudorandom quantum circuit;
adding, by the classical computer program, the probability for each of the pseudorandom quantum circuits to the running average score of randomness;
comparing, by the classical computer program, the running average score of randomness to a threshold; and
accepting, by the classical computer program, each of the samples in response to the running average score of randomness being greater than an average score of randomness threshold.

11. The method of claim 10, wherein the seed of entropy comprises a value of CPU jitter, time value, and/or a value based on a pattern of memory access.

12. The method of claim 10, wherein the step of generating the pseudorandom quantum circuit using the seed comprises:
seeding, by the classical computer program, a pseudorandom function with the seed.

13. The method of claim 10, wherein the threshold is based on a fidelity of the quantum computer.

14. The method of claim 10, wherein the threshold is based on a security parameter.

15. The method of claim 10, further comprising:
measuring, by the classical computer program, a time for the quantum computer program to return the samples; and
rejecting, by the classical computer program, the samples in response to the time being outside of a time threshold.

16. A non-transitory computer readable storage medium, including instructions stored thereon, which when read and executed by one or more computer processors, cause the one or more computer processors to perform steps comprising:
generating a pseudorandom graph having a depth, a number of nodes based on a number of qubits in a quantum computer, and edges between the nodes;
creating a coloring of the graph such that no two edges that share a node have the same color;
creating a graph coloring layer for each color that includes edges with that color;
generating a quantum circuit from the graph coloring layers;
estimating a cost of validating the quantum circuit;
determining that the cost is acceptable; and
saving the quantum circuit in response to the cost being acceptable.

17. The non-transitory computer readable storage medium of claim 16, further comprising:
increasing the depth in response to the cost being below a cost threshold.

18. The non-transitory computer readable storage medium of claim 16, wherein each edge represents a two-qubit gate, and a number of edges is equal to the depth.

19. The non-transitory computer readable storage medium of claim 16, wherein the quantum circuit is generated by concatenating the graph coloring layer, and for each graph coloring layer, a fixed two-qubit is appended to the quantum circuit, and for each qubit, a single qubit gate that is sampled uniformly from the space of all possible gates on a single qubit is appended to the quantum circuit.

20. The non-transitory computer readable storage medium of claim 16, wherein the cost is based on a number of floating-point operations required to validate the quantum circuit or a time to validate the quantum circuit.
